(19) United States
(12) Patent Application Publication
(10) Pub. No.: US 2026/0127290 A1
(43) Pub. Date: May 7, 2026

(54) PRE-EMPTIVE RISK QUANTIFICATION WITH HARM CAPACITY USING FOUNDATIONAL MODELS

(71) Applicant: International Business Machines Corporation, Armonk, NY (US)

(72) Inventors: Adam Lee Griffin, Cohasset, MN (US); Balaji Muthusamy Pandurangan, Amstelveen (NL); Vivek Soni, Pune (IN)

(73) Assignee: International Business Machines Corporation, Armonk, NY (US)

(21) Appl. No.: 18/937,489

(22) Filed: Nov. 5, 2024

(51) Int. Cl. G06F 21/57

(52) U.S. Cl. CPC G06F 21/577; G06F 2221/034

(57) ABSTRACT

An embodiment constructs a model of an IT system with multiple elements. Using the model, the embodiment generates threat data representing a potential threat to the IT system. The embodiment allocates value to each of the system elements. The embodiment models harm of the potential threat to the system elements based on the threat data. A neural network generates a quantified risk based on the modeled harm and the allocated value.

### BACKGROUND

The present invention relates generally to IT threat assessment. More particularly, the present invention relates to a method, system, and computer program for automated risk quantification.

In today's digital age, organizations heavily rely on IT infrastructure and AI capabilities to conduct their operations and store sensitive information. The integrity, availability, and security of this infrastructure are critical to business continuity and protecting sensitive data. However, with increasing complexity and interconnectivity of systems, the risk of cyberattacks and IT failures has also escalated. These risks can result in significant financial losses, data breaches, and reputational damage.

Organizations need a systematic and quantitative approach to evaluate and manage risks to their IT infrastructure. Traditional qualitative risk assessment methods are often subjective and lack precision, making it difficult to prioritize mitigation efforts effectively.

There is a pressing need for a solution that can assess risks based on internal policies, industry standards, and known vulnerabilities, and translate these risks into tangible financial impacts in terms of dollars. This helps in making informed decisions about risk management and resource allocation.

### SUMMARY

The illustrative embodiments provide for quantified cybersecurity threat assessment. An embodiment includes constructing a model of an information technology system comprising a plurality of system elements. The embodiment also includes generating, by assessing the model of the information technology system against data representing potential system exploits and vulnerabilities, threat data representing a potential threat to the information technology system. The embodiment also includes allocating value to each of the system elements. The embodiment also includes modeling, based on the threat data, harm of the potential threat to the system elements by assessing the impact of the potential threat on the system elements. The embodiment also includes generating, by a neural network, a quantified risk combining a likelihood of encountering the potential threat and the modeled harm of the potential threat to the system elements. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of threat assessment infrastructure in accordance with an illustrative embodiment;

FIG. 3 depicts a block diagram of an example cybersecurity risk assessment process in accordance with an illustrative embodiment; and

FIG. 4 depicts a block diagram of an example processing environment of a neural network in accordance with an illustrative embodiment.

### DETAILED DESCRIPTION

Modern IT threat detection and monitoring relies on a variety of monitoring and evaluation tasks, most of which rely on known exploits and vulnerabilities to identify outside threats. These tools focus on the information system architecture and how it interfaces with outside systems, highlighting points vulnerable to egress and the technical risks. An entity using these tools for threat assessment must then relate these technical risks to operational risks based on the nature and value of the vulnerable components, then take into account any internal vulnerabilities between compromised systems and other systems.

The present disclosure addresses the deficiencies described above by providing a process (as well as a system, method, machine-readable medium, etc.) that performs quantified threat assessment on IT systems. The nature and value of different components are evaluated to quantify the risk, and internal exploits and vulnerabilities are included in the quantified analysis. Embodiments identify areas where remediation or reconfiguration of security provides the most value for the entity.

The illustrative embodiments provide for quantified cybersecurity threat assessment. An “IT system” as used herein is any digital system that sends, receives, modifies, processes and/or stores data, and any connected combination of such systems. An “entity” is an owner or user of an IT system with data and/or operations that are at risk if the system is compromised and may include an individual or organization of any size.

The “value” of system components and/or data as used herein can mean both monetary and non-monetary value as provided by the entity.

The terms “compromise,” “exploit,” “breach,” “attack,” and the like are used interchangeably and generally for unauthorized access and/or use of an IT system in ways not permitted by the entity. A “threat” is a description of the circumstances that could lead to such unauthorized access. The likelihood and impact of a threat, taking into account the value of the compromised systems and data, are quantified as “risk.”

Illustrative embodiments include assessing an information technology system based on its configuration, network traffic and policies. Inputs to the assessment include threat, vulnerability, and exploit data.

Illustrative embodiments include allocating value to IT system elements. Quantitative risk assessments take into account the value of the elements, the harm from potential risks, and the likelihood of those risks.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

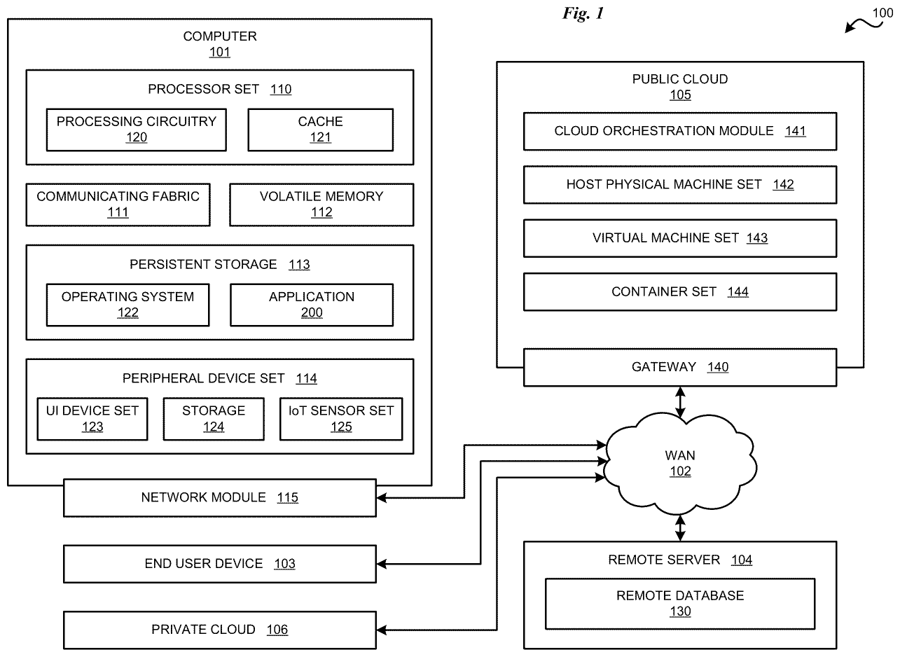

With reference to FIG. 1, this figure depicts a block diagram of a computing environment 100. Computing environment 100 contains an example of an environment for the execution of at least some of the computer code involved in performing the inventive methods, such as a threat assessment module 200 that projects energy output based on solar farm status and conditions, determines the effects of cloud seeding on the solar output, and sends instructions for selective cloud seeding when appropriate. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

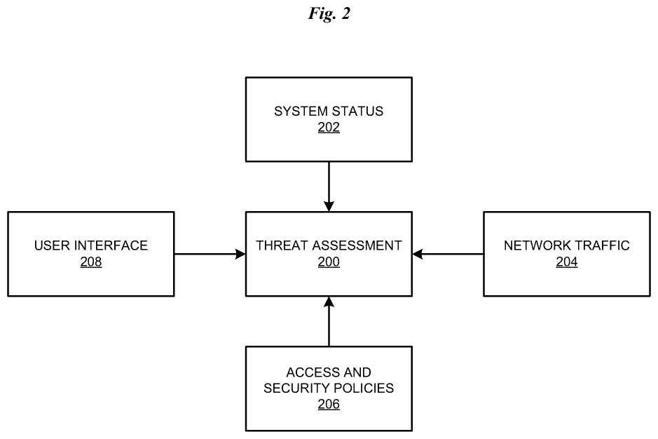

With reference to FIG. 2, this figure depicts a block diagram of an example threat assessment infrastructure in accordance with an illustrative embodiment. In the illustrated embodiment, the threat assessment infrastructure includes the threat assessment module 200 of FIG. 1. The threat assessment module 200 receives data from various tools monitoring aspects of the IT system. A system status module 202 monitors the health and performance of system components. A network traffic module 204 analyzes and logs communications between components as well as data entering and leaving the system. An access and security policies module 206 tracks permissions, data retention, and other settings within the IT system.

The threat assessment module 200 exchanges data with a user interface module 208, which may include a control panel, dashboard, or other user interface elements for receiving commands and displaying messages to users.

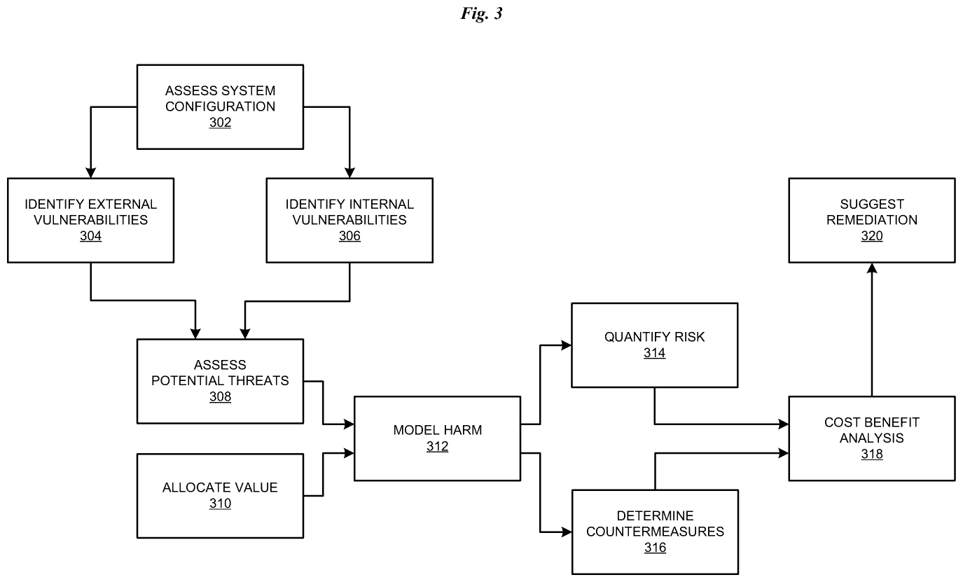

With reference to FIG. 3, this figure illustrates a flow diagram of an example process by which a threat assessment module 200 may make predictions. At step 302, components of the threat assessment infrastructure map and assess the system configuration. This includes the interrelation of system components, their connection to internal and external resources, and the policies in place to allow and control access. Based on the system configuration, the threat assessment module identifies external vulnerabilities (at step 304) and internal vulnerabilities (at step 306). External vulnerabilities include points where external threats may enter the IT system, such as network communications. Internal vulnerabilities include points where a compromised component may interact with other components, such as propagation of malware from one location to another.

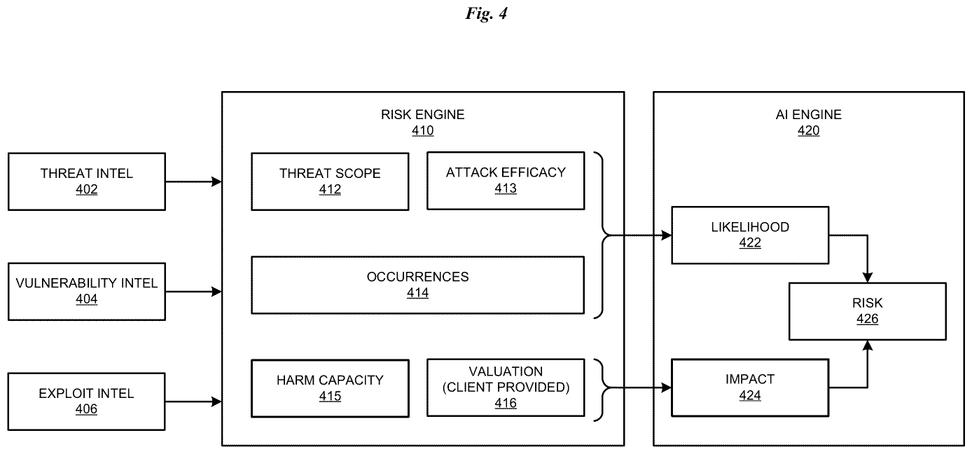

At step 308, the threat assessment module 200 evaluates potential threats based on the system configuration and vulnerabilities. The threat assessment module 200 takes into account all of the relevant intelligence and data gathered from different subsystems, including threat, vulnerability, and exploit intelligence as further described below with respect to FIG. 4. The nature of potential threats may depend on the threat environment and the availability of various attack vectors.

At step 310, the threat assessment module 200 allocates values to system elements. The embodiment may include some external valuation based on methodological and procedural knowledge. Value may be allocated based on information provided by the entity as to the monetary and/or non-monetary importance of particular data and processes. In some implementations, users associated with the entity may be prompted to provide information for the valuation of certain systems or elements.

At step 312, the threat assessment module 200 models harm to the system by evaluating the impact of potential threats in light of each element's value. Threats that escalate over time may be projected with a time-dependent model of harm, which may depend on both external and internal system vulnerabilities.

At step 314, the threat assessment module 200 combines the modeled impact of harm in each considered scenario with the likelihood of that scenario to produce quantified risk. This risk may be quantified in terms of a score under a known methodological framework, such as the “fair analysis of information risk” standard. The quantification may also be in terms of the expected or weighted costs associated with the assessed harm.

At step 316, the threat assessment module 200 determines countermeasures to prevent or mitigate harm. These countermeasures may be changes to system configuration, the introduction or modification of information security infrastructure, adjustments to protocols and policies, user information and training, and any other relevant steps for responding to the identified risk.

At step 318, the threat assessment module 200 performs a cost benefit analysis by comparing the quantified risks against the cost of potential countermeasures. Applying the likelihood and severity of certain scenarios against estimates of resource allocation for applying countermeasures, the system identifies the steps taken that provide the most cost effective harm reduction. At step 320, the threat assessment module 200 generates suggestions for remediation, providing details for the most effective countermeasures for reducing risk.

With reference to FIG. 4, this figure illustrates the use of neural networks in quantifying cybersecurity risks. A risk engine 410 combines threat intel 402, vulnerability intel 404, and exploit intel 406 to model scenarios where systems are compromised. The engine considers the threat scope 412 and attack efficiency 413 of each threat. Occurrences 414, including both known incursions and modeled possible incursions, are combined with data from threat scope 412 and data from attack efficiency 413 to produce likelihood data 422, representing the probability of each considered threat scenario.

The risk engine 410 also considered, based on vulnerability intel 404 and known/potential threats and exploits, harm capacity data 415. In combination with valuation data 416, which as noted and described above may be based on values provided by users associated with the entity, the risk engine 410 generates impact data 424 for each instance.

An AI engine 420 receives the likelihood data 422 and the impact data 424 as inputs in order to generate quantified risk data 426. The AI engine may be trained using known occurrences of harm and may take into account any and all available information to generate the quantified risk data 426, including system status and network traffic information, access and security policies, modeled harm, past and potential occurrences, as well as threat, vulnerability, and exploit intel. The quantified risk may be used to automatically suggest remediation measures, as described above.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration. ” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
constructing a model of an information technology system comprising a plurality of system elements;
generating, by assessing the model of the information technology system against data representing potential system exploits and vulnerabilities, threat data representing a potential threat to the information technology system;
allocating value to each of the system elements;
modeling, based on the threat data, harm of the potential threat to the system elements by assessing an impact of the potential threat on the system elements; and
generating, by a neural network, a quantified risk combining a likelihood of encountering the potential threat and the modeled harm of the potential threat to the system elements.

2. The computer-implemented method of claim 1, further comprising:
assessing, as part of constructing the model of the information technology system, configuration data for the information technology system.

3. The computer-implemented method of claim 1, further comprising:
assessing, as part of constructing the model of the information technology system, network traffic data for the information technology system.

4. The computer-implemented method of claim 1, further comprising:
assessing, as part of constructing the model of the information technology system, policy data for the information technology system.

5. The computer-implemented method of claim 1, further comprising:
assessing, as part of allocating value to each of the system elements, a user-submitted valuation of one or more of the system elements.

6. The computer-implemented method of claim 1, further comprising:
generating a first countermeasure to the potential threat; and
sending steps for implementing the first generated countermeasure to a user of the information technology system.

7. The computer-implemented method of claim 6, further comprising:
modeling a harm reduction of the potential threat from implementing the first generated countermeasure; and
evaluating the first generated countermeasure based on the modeled harm reduction.

8. The computer-implemented method of claim 7, further comprising:
generating a second countermeasure to the potential threat;
modeling a harm reduction of the potential threat from implementing the second generated countermeasure;
evaluating the second generated countermeasure based on the modeled harm reduction, and
sending, based on the modeled harm reductions of the first and the second generated countermeasures, steps for implementing the first generated countermeasure to a user of the information technology system and not the second generated countermeasure.

9. The computer-implemented method of claim 6, the potential threat being a first potential threat, the method further comprising:
generating, using the model of the information technology system, second threat data representing a second potential threat to the information technology system;
modeling, based on the second threat data, harm of the second potential threat to the system elements;
generating, by the neural network based on the modeled harm of the second potential threat and the allocated value, a second quantified risk;
generating a second generated countermeasure to the second potential threat;
evaluating the first countermeasure to the first potential threat in comparison to the second countermeasure to the second potential threat; and
sending, based on evaluating the first and second countermeasures, steps for implementing the first generated countermeasure to a user of the information technology system and not the second generated countermeasure.

10. A computer program product comprising one or more computer readable storage media, and program instructions collectively stored on the one or more computer readable storage media, the program instructions executable by a processor to cause the processor to perform operations comprising:
constructing a model of an information technology system comprising a plurality of system elements;
generating, by assessing the model of the information technology system against data representing potential system exploits and vulnerabilities, threat data representing a potential threat to the information technology system;
allocating value to each of the system elements;
modeling, based on the threat data, harm of the potential threat to the system elements by assessing an impact of the potential threat on the system elements; and
generating, by a neural network, a quantified risk combining a likelihood of encountering the potential threat and the modeled harm of the potential threat to the system elements.

11. The computer program product of claim 10, wherein the stored program instructions are stored in a computer readable storage device in a data processing system, and wherein the stored program instructions are transferred over a network from a remote data processing system.

12. The computer program product of claim 10, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

13. The computer program product of claim 10, further comprising:
assessing, as part of constructing the model of the information technology system, configuration data for the information technology system.

14. The computer program product of claim 10, further comprising:
assessing, as part of constructing the model of the information technology system, network traffic data for the information technology system.

15. The computer program product of claim 10, further comprising:
assessing, as part of constructing the model of the information technology system, policy data for the information technology system.

16. The computer program product of claim 10, further comprising:
assessing, as part of allocating value to each of the system elements, a user-submitted valuation of one or more of the system elements.

17. The computer program product of claim 10, further comprising:
generating a first countermeasure to the potential threat; and
sending steps for implementing the first generated countermeasure to a user of the information technology system.

18. A computer system comprising a processor and one or more computer readable storage media, and program instructions collectively stored on the one or more computer readable storage media, the program instructions executable by the processor to cause the processor to perform operations comprising:
constructing a model of an information technology system comprising a plurality of system elements;
generating, by assessing the model of the information technology system against data representing potential system exploits and vulnerabilities, threat data representing a potential threat to the information technology system;
allocating value to each of the system elements;
modeling, based on the threat data, harm of the potential threat to the system elements by assessing an impact of the potential threat on the system elements; and
generating, by a neural network, a quantified risk combining a likelihood of encountering the potential threat and the modeled harm of the potential threat to the system elements.

19. The computer system of claim 18, further comprising:
generating a first countermeasure to the potential threat; and
sending steps for implementing the first generated countermeasure to a user of the information technology system.

20. The computer system of claim 19, further comprising:
modeling a harm reduction of the potential threat from implementing the first generated countermeasure; and
evaluating the first generated countermeasure based on modeled harm reduction.
